(19) United States
(12) Patent Application Publication
(10) Pub. No.: US 2017/0228810 A1
(43) Pub. Date: Aug. 10, 2017

(54) ITEM RECOMENDATION

(71) Applicant: Hewlett-Packard Enterprise Development LP, Houston, TX (US)

(72) Inventors: Hongwei Shang, Palo Alto, CA (US); Yong Liu, Palo Alto, CA (US); Mehran Kafai, Redwood City, CA (US); April Slayden Mitchell, San Jose, CA (US)

(21) Appl. No.: 15/502,523

(22) PCT Filed: Sep. 26, 2014
(86) PCT No.: PCT/US2014/057712

§ 371 Date: Feb. 8, 2017

(51) Int. Cl. G06Q 30/06; G06F 7/02; G06Q 10/06

(52) U.S. Cl. CPC G06Q 30/0631; G06Q 10/067; G06F 7/026

(57) ABSTRACT

An example method is provided in according with one implementation of the present disclosure. The method includes extracting features related to a plurality of users and a plurality of items and computing a correction parameter score for each of a plurality of user-item pair combinations. The method further includes computing a user response value for a user-item pair combination by applying a generalized linear model to the features of the user-item pair combination and using the correction parameter score for the user-item pair combination in the generalized linear model.

### BACKGROUND

Systems that automatically suggest an item of potential interest to users or filter items (i.e., recommendation systems) continue to play an important role today. Organizations and individuals regularly use different types of recommendation systems in various areas and for different applications. For example, many web-sites use various recommendation techniques in order to provide recommendations to users.

### BRIEF DESCRIPTION OF THE DRAWINGS

FIG. 1 is a schematic illustration of an example recommendation system in accordance with an implementation of the present disclosure.

FIG. 2 illustrates a flow chart showing an example of a method for calculating a response value in accordance with an implementation of the present disclosure.

FIG. 3 illustrates a flow chart showing an example of a method for extracting features related to a plurality of users and a plurality of items in accordance with an example implementation of the present disclosure.

FIG. 4 illustrates a flow chart showing an example of a method for computing a response value for a user-item pair combination in accordance with an example implementation of the present disclosure.

FIG. 5 is an example block diagram illustrating a computer-readable medium to compute a response value for a user-item pair combination in accordance with an implementation of the present disclosure.

### DETAILED DESCRIPTION OF SPECIFIC EXAMPLES

With the recent improvements in technology, systems that automatically suggest an item of potential interest to a user or filter different items (i.e., recommendation systems) are becoming increasingly popular in all industries. As used herein, the term “user” refers to any type of individual, organization, group, business, or any other party that may need to select between different items or may receive a recommendation for an item. Generally, users or customers are offered large selections of products or service by merchants. Since users often have to decide which items to select (e.g., purchase, consume, recommend, etc.) while faced with a large number of choices, such recommendation systems are frequently used by individuals and organizations. As used herein, the term “item” refers to any type of product, service, object, category, or any other article or information that may be subject to user selection or recommendation. For example, a user may receive recommendation for or may need to choose between products (e.g., clothing, electronics, etc.), movies, music, news, books, research articles, advertisements, social tags, jokes, restaurants, financial services, life insurance, persons (e.g., online dating), etc.

Therefore, recommendation systems help users explore their interests and make selections related to any type of information. As a result, these systems are widely used by organization, businesses, or individual users. Selecting or advertising products that suit the users' personal taste and need help to enhance users' experience and increase the merchants' revenue. Computing systems and devices continue to assist users with automatically suggestion and recommendation. As used herein, the terms “electronic device,” “computing device,” and “computer” are to be used interchangeably and refer to any one of various personal computers, printers, smartphones, wearable electronic devices, display screens, tablets, personal data assistants (PDA's), laptops, servers, and other similar electronic devices that include a processor and memory.

Some of the techniques used in recommendation systems include collaborative filtering (CF) and content-based filtering (CBF). Collaborative filtering techniques may analyze a user's past behavior (e.g., items previously purchased, liked, or selected by the user and/or ratings given to those items) as well as similar decisions made by other users. These CF techniques use that information to predict items (or ratings for items) that the user may have an interest in or may be recommended to the user. CF relies only on users' previous transaction history or users' ratings and it completely ignores any information that could be extracted from semantic content.

Content-based filtering techniques utilize data about the user (e.g., personal information, social-economic information, etc.) and content information of an item (e.g., item characteristics, description, etc.) in order to recommend additional items with similar properties. For example, each user and each item can be represented by a profile including a set of features (i.e., characteristics) describing the user or the item. For a user, such features may include age, gender, income, residence (e.g., zip code), etc, For an item (e.g., a movie), such features may include actors, genre, review ratings, director, budget, country of origin, etc, However, CBF does not utilize feedback information collected from transaction history or users' ratings.

One problem with available mechanisms used in recommendation systems is that they may not produce an accurate prediction or recommendation for an item. Further, these techniques may be slow in processing the information they have. Therefore, improved techniques for automatically suggesting an item of potential interest to a user or filtering different items are desired.

Hybrid methods that combine CF and CBF techniques may be used to improve the quality of a recommendation. However, most hybrid recommender methods fall into one of the following two categories and still may fail to provide accurate predictions or recommendations. The first hybrid design is a parallelized hybridization design, where parallelized recommendation systems operate independently of one another and produce separate recommendation lists. Then, their output is combined into a final set of recommendations by using weighted or switching strategies. The second hybrid design is a pipelined hybridization design, where several recommender systems are joined together in a pipeline architecture and the output of one recommender system is part of the input of the subsequent one. The above two hybrid designs treat several recommender systems separately and combine their results only, while their correlation is completely ignored.

The present description is directed to methods, systems, and computer readable media that provide improved recommendations or filtering of user desired items. The present description proposes a monolithic hybrid design, which uniquely integrates two recommendation techniques in one algorithm implementation. In the proposed approach, hybridization is achieved by a built-in modification of the algorithm.

Specifically, the proposed approach extends the traditional content-based filtering by combining it with item-based collaborative filtering in a novel way. The proposed approach may use features related to a plurality of users, a plurality of items, user-item interaction features (e.g., extracted via CBF techniques), and correction parameter scores (e.g., representing user's tendency to like, purchase, etc. an item) for each of a plurality of user-item pair combinations (e.g., computed via CF techniques). A generalized linear model may be used to compute coefficients for the features of plurality of users, items, and user-item pairs interactions. The generalized linear model may be augmented with the correction parameter score of a selected user-item pair. All predicator variables (e.g., features, correction parameter scores, etc.) work together mutually on computing the response value that represents the user's potential interest in the item.

The proposed approach achieves a higher precision in recommending an item. The approach is general enough to include all features related to a user-item pair. For example, in addition to user features and item features the approach uses the interaction effects/features between a user and an item (e.g., user's shopping behavior information, their wish list, and their shopping cart information). The computation in the proposed model may be performed faster as compared to other hybrid models which are more complicated.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description ad should not be regarded as limiting. The use of “including,” “comprising” or “having” and variations thereof herein is meant to encompass the items listed thereafter and equivalents thereof as well as additional items. Furthermore, the term “based on,” as used herein, means “based at least in part on.” It should also be noted that a plurality of hardware and software based devices, as well as a plurality of different structural components may be used to implement the disclosed methods and devices.

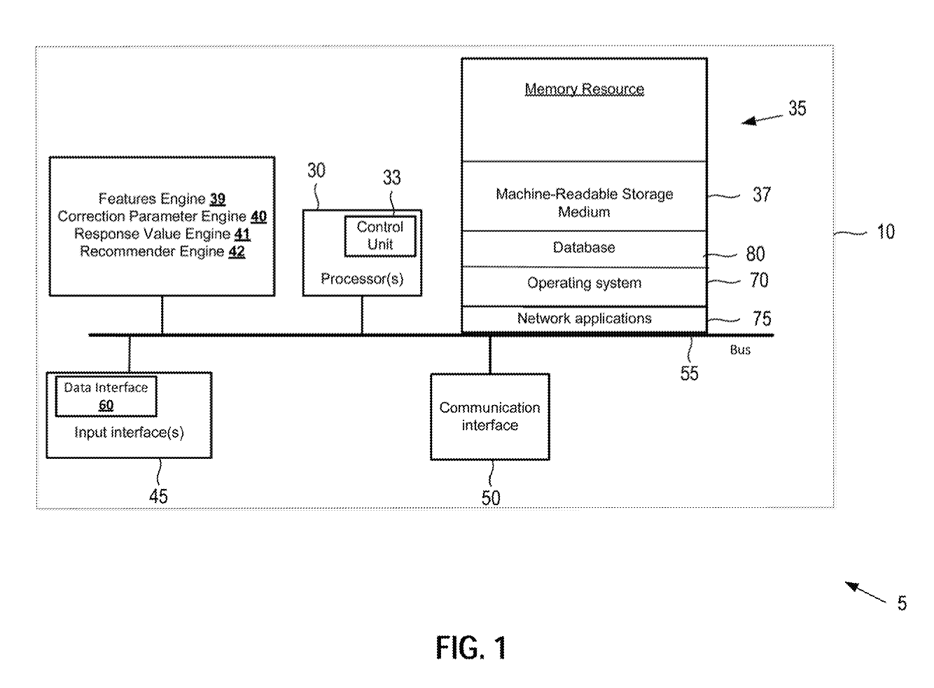

FIG. 1 is a schematic illustration of an example recommendation system 5 for automatically suggesting an item of potential interest to a user or for filtering different items. The illustrated system 5 is capable of carrying out the techniques described below. As shown in FIG. 1, the system 5 is depicted as including an electronic or computing device 10. It is to be understood that the techniques described in relation to the device 10 may be implemented with any other electronic/computing device or a combination of electronic/computing devices.

For example, the computing device 10 may be a laptop, a personal computer, a tablet, an all in one computing device, a gaming console, a server, a smartphone, a visual player, a personal digital assistant (PDA), a cellular telephone, an electronic notepad, a plurality of distributed computing devices, a card or a chip on the system board embedded in a computing device, or any other suitable computing device that includes a processor. In the illustrated example, the computing device 10 may include at least one processor 30, a memory resource 35, engines 39-42, an input interface(s) 45, and a communication interface 50.

In other examples, the computing device 10 may include additional components and some of the components depicted therein may be removed and/or modified without departing from a scope of the system that allows for carrying out the functionality described herein. It is to be understood that the operations described as being performed by the computing device 10 that are related to this description may, in some implementations, be performed or distributed between the computing device 10 and other electronic/computing devices (not shown).

As explained in additional details below, the computing device 10 may include software, hardware, or a suitable combination thereof configured to enable functionality of the computing device 10 and to allow it to carry out the techniques described below and to interact with the one or more systems or devices. The computing device 10 may include communication interfaces (e.g., a Wi-Fi® interface, a Bluetooth® interface, a 3G interface, a 4G interface, a near field communication (NFC) interface, etc.) that are used to connect with other devices/systems and/or to a network (not shown). The network may include any suitable type or configuration of network to allow for communication between the computing device 10 and any other devices/systems (e.g., other electronic devices, computing devices, displays, etc.).

The processor 30 of the computing device 10 (e.g., a central processing unit, a group of distributed processors, a microprocessor, a microcontroller, an application-specific integrated circuit (ASIC), a graphics processor, a multiprocessor, a virtual processor, a cloud processing system, or another suitable controller or programmable device), the memory resource 35, the engines 39-42, the input interfaces 45, and the communication interface 50 may be operatively coupled to a bus 55. The processor 30 may be suitable to retrieve and execute instructions stored in machine-readable storage medium. Processor 30 can include single or multiple cores on a chip, multiple cores across multiple chips, multiple cores across multiple devices, or combinations thereof. The processor 30 may include at least one controller 33 (also called a control unit) and may be implemented using any suitable type of processing system where at least one processor executes computer-readable instructions stored in the memory 35.

The communication interface 50 may allow the computing device 10 to communicate with plurality of networks, communication links, and external devices. The input interfaces 45 may receive information from devices/systems in communication with the computing device 10. In one example, the input interfaces 45 include at least a data interface 60 that may receive data (e.g., user data, item data, etc.) from any external device or system.

The memory resource 35 may include any suitable type, number, and configuration of volatile or non-transitory machine-readable storage media 37 to store instructions and data. Examples of machine-readable storage media 37 in the memory 35 include read-only memory (“ROM”), random access memory (“RAM”) (e.g., dynamic RAM [“DRAM”], synchronous DRAM [“SDRAM”], etc.), electrically erasable programmable read-only memory (“EEPROM”), magnetoresistive random access memory (MRAM), memristor, flash memory, SD card, floppy disk, compact disc read only memory (CD-ROM), digital video disc read only memory (DVD-ROM), and other suitable magnetic, optical, physical, or electronic memory on which software may be stored. The memory resource 35 may also be used for storing temporary variables or other intermediate information during execution of instructions to by the processor 30.

The memory 35 may also store an operating system 70 and network applications 75. The operating system 70 may be multi-user, multiprocessing, multitasking, multithreading, and real-time. The operating system 70 may also perform basic tasks such as recognizing input from input devices; sending output to output devices; keeping track of files and directories on memory 35; controlling peripheral devices, such as printers, image capture devices, etc.; and managing traffic on the bus 55. The network applications 75 include various components for establishing and maintaining network connections, such as computer-readable instructions for implementing communication protocols.

The memory 35 may include at least one database 80. In other example implementations, the device 10 may access an external database (not shown) that may be stored remotely of the computing device 10 (e.g., can be accessed via a network or a cloud). The database 80 may store various information to be processed by the device 10, such as data about different users, items, etc.

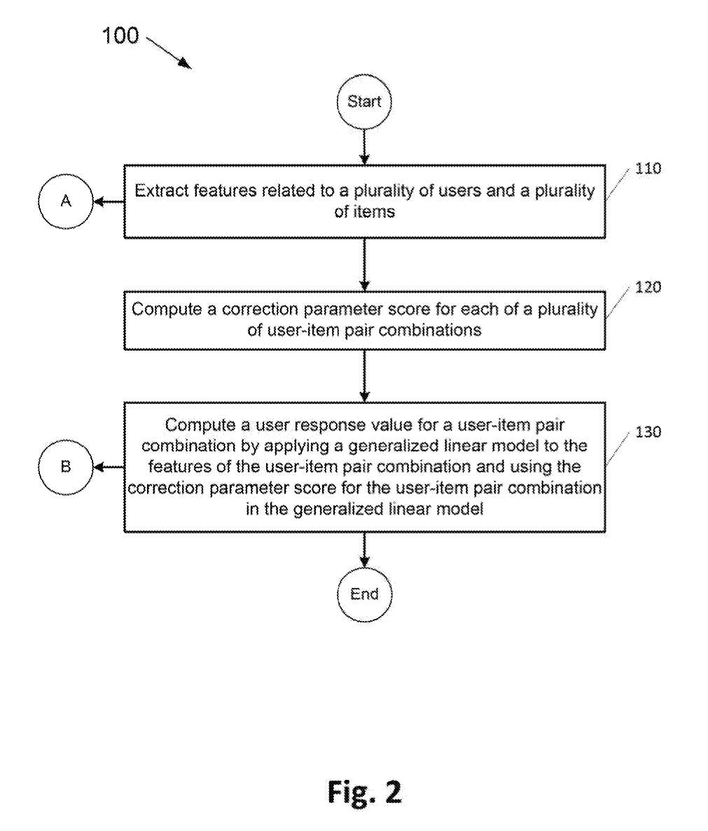

The computing device 10 may include various engines 39-42. Each of he engines 39-42 may include, for example, at least one hardware device including electronic circuitry for implementing the functionality described below, such as control logic and/or memory. In addition or as an alternative, the engines 39-42 may be implemented as any combination of hardware and programming to implement the functionalities of the engines. For example, the hardware may be a processor and the programming may be a series of instructions or microcode encoded on a machine-readable storage medium and executable by the processor. Therefore, as used herein, an engine may include program code, e.g., computer executable instructions, hardware, firmware, and/or logic, or combination thereof to perform particular actions, tasks, and functions described in more detail herein in reference to FIGS. 2-4.

The features engine 39 may identify features related to a plurality of users and a plurality of items. For example, the features engine 39 may extract user features related to each user from the plurality of users, item features related to each item from the plurality of items, and user-item interaction features related to interactions between a user and an item in each of the user-item pair combinations.

The correction parameter engine 40 may compute a correction parameter score for each of a plurality of user-item pair combinations. The correction parameter score may be a numerical value that represents the relationship between a user and a specific item based on available data for the user and the item. In one example, the correction parameter score may represent a user's tendency to like an item.

The response value engine 41 may compute a user response value for a user-item pair combination by applying a generalized linear model to the features of the user-item pair combination and augmenting the generalized linear model with the correction parameter score for the user-item pair combination. The user response value may be a real value and may express or predict a user's interest in a specific item. Thus, the output of a recommendation system may be based on the user response value.

In one example, the response value engine 41 may compute coefficients for the user features, the item features, and the user-item interaction features of the plurality of user-item pair combinations for the generalized linear model by adding the correction parameter scores and the features of the plurality of user-item pair combinations to the model. Further, the response value engine 41 may use the coefficients, the user features, the item features, the user-item interaction features for a user-item pair combination, and the correction parameter score for the user-item pair combination to compute the user response value for the user-item pair combination.

The recommender engine 42 may provide an item recommendation based on the user response value by a recommendation system. In one example, the recommender engine 42 may directly or indirectly communicate (e.g., send, display, etc.) to a user a recommended/candidate item from a set of candidate items (e.g., products, movies, etc.) based on the user response value determined by the engine 41.

FIG. 2 illustrates a flow chart showing an example of a method 100 for calculating a response value. It is to be understood that the method may be applicable to all types of users and items and may be used to automatically suggest that an item is of potential interest to a user. One goal of the method 100 is to predict a user response value for a user-item pair. The response value determined by the method 100 may represent a user's potential interest (e.g., propensity to buy, like, recommend, view, etc.) in an item.

Although execution of the method 100 is described below with reference to the system 5 and the device 10, other suitable components for execution of the method 100 can be utilized. Additionally, the components for executing the method 100 may be spread among multiple devices. In certain scenarios, multiple devices acting in coordination can be considered a single device to perform the method 100. The method 100 may be implemented in the form of executable instructions stored on a machine-readable storage medium, such as storage medium 37, and/or in the form of electronic circuitry.

In one example, the method 100 can be executed by the processor 30 of the computing device 10. Various elements or blocks described herein with respect to the method 100 are capable of being executed simultaneously, in parallel, or in an order that differs from the illustrated serial manner of execution. The method 100 is also capable of being executed using additional or fewer elements than are shown in the illustrated examples.

The method 100 begins at 110, where the processor 30 may extract features related to a plurality of users and a plurality of items. In one example, the features are extracted by using a content based filtering technique. There may be data related to a plurality of users and a plurality of items. In one example, (i,j) may represent a pair of a user i (i=1, . . . I) and an item (j=1, . . . j). The features related to the plurality of users and the plurality of items may be extracted from various data (e.g., training data, etc.) related to the users and the items (e.g., user's personal information, transaction history for the user, profile information, item description, etc.). Alternatively, the features may be received from another computing device (not shown) or may be retrieved from the memory 35 of the device 10. The extracted features may be numerical values (e.g., age, salary, etc.) or categorical values (gender, etc.) that may be converted to numerical values.

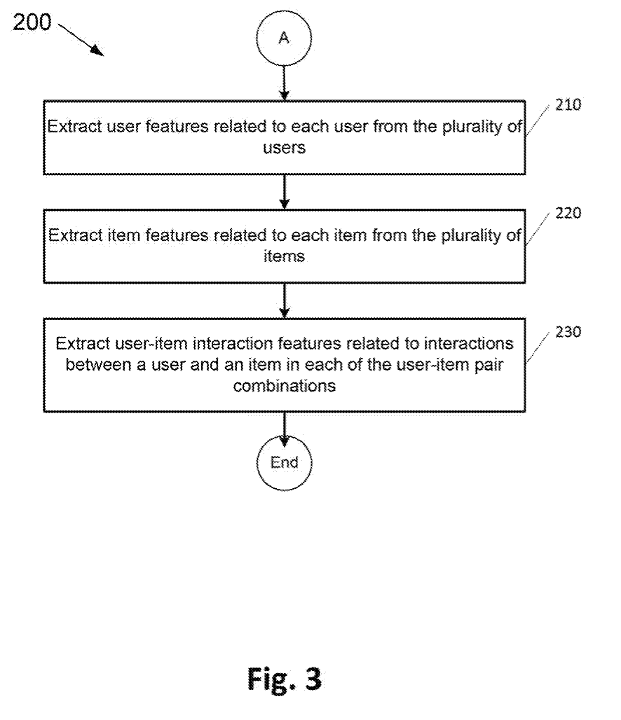

FIG. 3 illustrates a flow chart showing an example of a method 200 for extracting features related to a plurality of users and a plurality of items. In one example, the method 200 can be executed by the processor 30 of the computing device 10. Alternatively, the components for executing the method 200 may be spread among multiple devices.

For example, for each user-item pair (i,j) the processor may extract three types of features—user features, item features, and user-item interaction features. The method 200 begins at 210, where the processor may extract user features related to each user from the plurality of users. In one implementation, Uᵢ=(U_{i,1}, . . . , U_{i,q}) denotes a feature vector for a user i with q features (where q indicates the number of user features). User features may include gender, sex, income, age, etc., and any other features that may be related to a user. At 220, the processor may extract item features related to each item from the plurality of items. For example, Vⱼ=(V_{j,1}, . . . , V_{j,s}) denotes a feature vector for an item j with s features (where s indicates the number of item features). Item features may include content information, product category, year made, description, and any other type of applicable item data. For instance, when the item is a movie, such extracted features may include actors, genre, review ratings, director, budget, country of origin, etc,

At 230, the processor may extract user-item interaction features related to interactions between a user and an item in each of the user-item pair combinations. For example, W_{i,j}=(W_{i,j,1}, . . . , W_{i,j,g}) denotes a feature vector for the interaction between a user i and an item j with g features, such as browsing behavior of the user related to the item, wish list including the item, shopping cart information, etc. Thus, the processor 30 extracts user features, item features, and user-item interaction features for every user-item pair combination.

With continued reference to FIG. 2, at 120, the processor may compute a correction parameter score for each of a plurality of user-item pair combinations. In one example the correction parameter score is computed by using an item-based collaborative filtering technique. For instance, fᵢⱼ may denote a correction parameter score for the pair (i, j) of a user and an item. In one implementation, the processor 30 may use item-based collaborative filtering technique to analyze a user-item matrix (e.g., retrieved from user's transactional history, user's ratings, etc.) to identify relationships among items. In some examples the data for the matrix may be retrieved from a user's profile information, transaction history of the user, purchase data, rating, viewing data, etc.

Then, the processor may compute a correction parameter score fᵢⱼ with item j for user i based on relationships between different items. The correction parameter score fᵢⱼ may be a numerical value (e.g., between 0 and 1) that represents the relationship between a user and a specific item based on available data for the user and the item. In one example, the correction parameter score may represent a predicted user's tendency to like an item. In another example, the correction parameter score may represent a predicted user's tendency to purchase an item, etc. A higher score means a higher tendency that a user may like/buy an item. In other examples, alternative techniques may be used to compute a correction parameter score f,ⱼ. As explained in additional details below, the correction parameter score fᵢⱼ may be used to augment a generalized linear model and to assist in computing a user response value for a user-item pair combination by applying the generalized linear model to the features of the user-item pair combination,

Next, at 130, the processor computes a user response value for a user-item pair combination by applying a generalized linear model to the features of the user-item pair combination and using the correction parameter score for the user-item pair combination in the generalized linear model. In other words, the proposed method uses the features for a specific item-pair and the correction parameter score in a generalized linear model to compute the user response value for the specific user-item pair combination, Specifically, a logistic regression model may be “fitted” using the features from the plurality of user and items; coefficients for the user features, the item features, and the user-item interaction features of the plurality of user-item pair combinations for the generalized linear model may be computed; and a logistic function (i.e., logit) of the user response value may be computed by using the features, the coefficients, and a logit of the correction parameter score for the specific user-item pair. Thus, in some examples, the generalized linear model may be a logistic regression model. In other examples, the generalized linear model may be another type of regression model.

In one example, ŷ_{i,j} may represent the user response value (e.g., an estimated value) for a user-item pair. This user response value may be a real value and may express user's interest in an item. The user response value may be a value between 0 and 1 (e.g., 0.82), where 1 may express an expectation that a user may buy, recommend, etc. an item and 0 may express an expectation that a user may not buy, recommend, etc. an item. Alternatively, the user response value may be a real value (e.g., 3.6) between any other set of numbers (e.g., set of 1-5) when that value is used to rate an item (e.g., from 1-5).

In some examples, user response value y_{i,j} may be computed by computing the probability distribution p_{i,j} of the user response value y_{i,j}. The user response value y_{i,j} may follow a Bernoulli distribution with the probability distribution p_{i,j}. Then, the probability distribution p_{i,j} of y_{i,j} may be:

P(yᵢⱼ)=pᵢⱼ^{y}^{_{i,j}}(1−pᵢⱼ)^{1-y}^{ᵢⱼ}

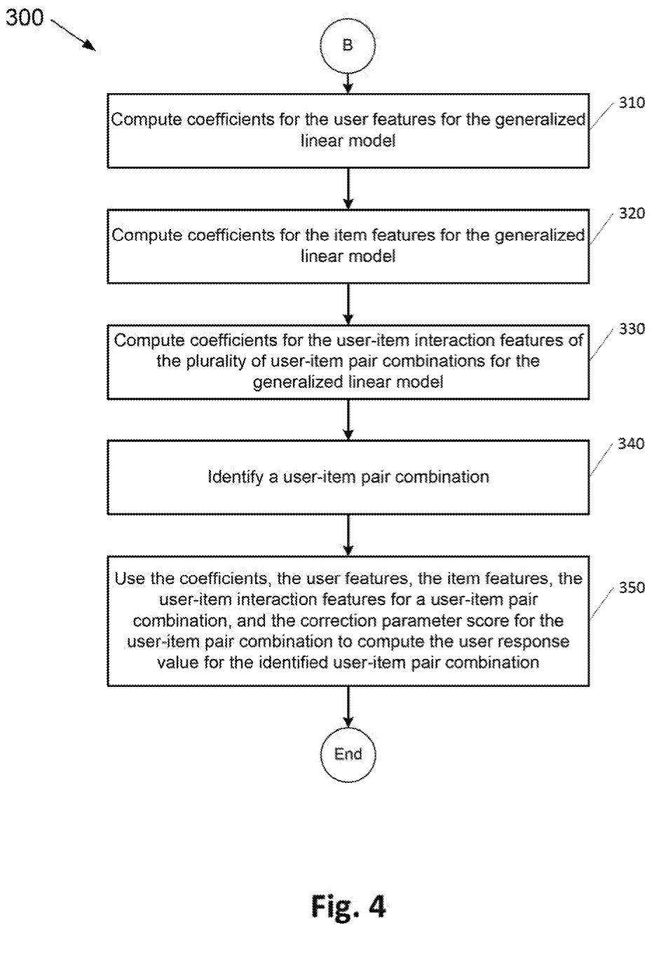

FIG. 4 illustrates a flow chart showing an example of a method 300 for computing a response value for a user-item pair combination in accordance with an example implementation of the present disclosure. In one example, the method 300 can be executed by the processor 30 of the computing device 10. Alternatively, the components for executing the method 300 may be spread among multiple devices.

At 310, the processor may compute coefficients for the user features for the generalized linear model. At 320, the processor may compute the coefficients for the item features for the generalized linear model. At 330, processor may compute the user-item interaction features of the plurality of user-item pair combinations for the generalized linear model. It is to be understood that, in one example, the coefficients for user features, coefficients for item features, and coefficients for user-item interaction features may be computed (e.g., estimated) simultaneously by the processor. In one implementation, α, β, and γ respectively may represent the coefficients (e.g., regression coefficients) for the user features, the item features, and the user-item interaction features—α=(α₁, . . . , α_{q}), β=(β₁, . . . , β_{S}), and γ=((γ₁, . . . , γ_{,g}). For example, the coefficients α, β, and γ for the generalized linear model may be computed by adding the correction parameter scores (computed separately) and the features of the plurality of user-item pair combinations to the generalized linear model (e.g., by using a maximum likelihood estimation technique), Thus, in computing the coefficients, the processor may use features data related to the plurality of users and items and all available correction parameter scores for all pairs of users and items in the generalized linear model. In other words, the generalized linear model is “fitted” with the available data to compute the coefficients.

Next, at 340, the processor identifies a user-item pair combination for which a user response value is to be computed. The user-item pair combination may be inputted from a user, selected by the processor, or it may be identified by any other reasonable manner.

At 350, the processor may use the coefficients α, β, and γ, the user features, the item features, the user-item interaction features for a user-item pair combination, and the correction parameter score for the user-item pair combination to compute the user response value for the user-item pair combination. In one example, the logistic function (i.e., logit) of the probability distribution p_{i,j} may be: logit (pᵢⱼ)=log[pᵢⱼ/(1−pᵢⱼ)].

Then, in one example, the generalized linear model may have the following form:

logit(pᵢⱼ)˜logit(fᵢⱼ)+α^{T}Uᵢ+β^{T}Vⱼ+γ^{T}W_{i,j}

Where logit (pᵢⱼ) represents the logistic function of the probability distribution p_{i,j}, logit (fᵢⱼ) represents the logistic function of the correction parameter score fᵢⱼ for the identified user-item pair, and α^{T}Uᵢ+β^{T}Vⱼ+γ^{T}W_{i,j} represent the relationship between features U, V, W (i.e., item, user, and user-item interaction) and the coefficients α, β, and γ for the features. Thus, in order to compute the user response value y_{i,j} for a user-item pair, the processor models the logit of the probability p_{i,j} for y_{i,j} by using the logit(fᵢⱼ) of the correction parameter score fᵢⱼ and a linear function of the features and the computed coefficients. All features related to a user-item pair combination (e.g., the user features, the item features, and the user-item interaction features for a user-item pair combination) work together mutually (i.e., their mutual relationship is considered) to predict the user response value.

The computed user response value may be used in different ways. In one example, based on the user response value, the processor 30 (or another processor that may receive the value) may provide an item recommendation. In another example, user response value may be used to support a selection between a plurality of items (e.g., when a user must select between different items).

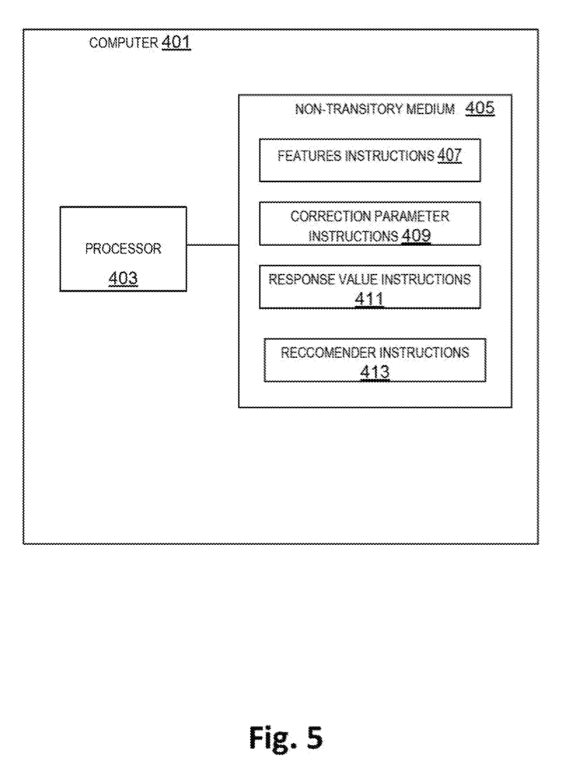

FIG. 5 illustrates a computer-readable medium to compute a response value for a user-item pair combination, according to an example. Computer 401 may include and/or be implemented by one or more computers. For example, the computers may be server computers, workstation computers, desktop computers, laptops, mobile devices, or the like, and may be part of a distributed system. The computers may include one or more controllers and one or more machine-readable storage media.

In addition, users of computer 401 may interact with computer 401 through one or more other computers, which may or may not be considered part of computer 401. As an example, a user may interact with computer 401 via a computer application residing on a computer, such as a desktop computer, workstation computer, tablet computer, or the like. The computer(s) and computer application can include a user interface (e.g., touch interface, mouse, keyboard, gesture input device, etc.).

Computer 401 may perform methods 100, 200, 300 and variations thereof. Additionally, the functionality implemented by computer 401 may be part of a larger software platform, system, application, or the like. Computer 401 may be connected to database (not shown) via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

The computer 401 may include a processor 403 and non-transitory machine-readable storage media 405. The processor 403 may be similar to the processor 30 of the computing device 10 and non-transitory machine-readable storage media 405 may be similar to the machine-readable storage media 37 of the device 10. Software stored on the non-transitory machine-readable storage media 405 and executed by the processor 403 includes, for example, firmware, applications, program data, filters, rules, program modules, and other executable instructions. The processor 403 retrieves from the machine-readable storage media 405 and executes, among other things, instructions related to the control processes and methods described herein.

The processor 403 may fetch, decode, and execute instructions 407-413 among others, to implement various processing. As an alternative or in addition to retrieving and executing instructions, processor 403 may include at least one integrated circuit (IC), other control logic, other electronic circuits, or combinations thereof that include a number of electronic components for performing the functionality of instructions 407-413. Accordingly, processor 403 may be implemented across multiple processing units and instructions 407-413 may be implemented by different processing units in different areas of computer 401.

The instructions 407-413 when executed by processor 403 (e.g., via one processing element or multiple processing elements of the processor) can cause processor 403 to perform processes, for example, methods 100-300, and/or variations and portions thereof. In other examples, the execution of these and other methods may be distributed between the processor 403 and other processors in communication with the processors 403.

For example, features instructions 407 may cause processor 403 to identify features related to a plurality of users and a plurality of items. These instructions may function similarly to the techniques described in block 110 of method 100 and the method 200. For example, features instructions 407 may cause processor 403 to extract user features related to each user from the plurality of users, extract item features related to each item from the plurality of items, and extract user-item interaction features related to interactions between a user and an item in each of the user-item pair combinations.

Correction parameter instruction 409 may cause the processor 403 to compute a correction parameter score for each of a plurality of user-item pair combinations. These instructions may function similarly to the techniques described block 120 of method 100. For example, the correction parameter score may be a numerical value that represents the relationship between a user and a specific item based on available data for the user and the item (e.g., it may represents a predicted user's tendency to like, purchase, etc. an item).

Response value instructions 411 may cause the processor 403 to compute a user response value for an identified user-item pair combination by applying a generalized linear model to the features of the user-item pair combination and augmenting the generalized linear model with the correction parameter score for the user-item pair combination. These instructions may function similarly to the techniques described block 130 of method 100 and the method 300. For example, the response value instructions 411 may cause the processor 403 to compute coefficients for the user features, the item features, and the user-item interaction features of the plurality of user-item pair combinations for the generalized linear model, by adding the correction parameter scores and the features of the plurality of user-item pair combinations to the generalized linear model. Further, the response value instructions 411 may cause the processor 403 to use the coefficients, the user features, the item features, the user-item interaction features for the identified user-item pair combination, and the correction parameter score for the identified user-item pair combination to compute the user response value for the identified user-item pair combination. Further processing may be performed, as previously described with respect to methods 100-300.

Recommender instructions 413 may cause the processor 403 to provide an item recommendation based on the user response value. These instructions may function similarly to the techniques described in relation to the recommender engine 42. Specifically, the recommender instructions 413 may cause the processor 403 to communicate (e.g., send, display, etc.) to a user a recommended item from a set of candidate items (e.g., products, etc.) based on the user response value.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method comprising, by at least one processor
extracting features related to a plurality of users and a plurality of items;
computing a correction parameter score for each of a plurality of user-item pair combinations; and
computing a user response value for a user-item pair combination by applying a generalized linear model to the features of the user-item pair combination and using the correction parameter score for the user-item pair combination in the generalized linear model.

2. The method of claim 1, wherein extracting features further comprises:
extracting user features related to each user from the plurality of users;
extracting item features related to each item from the plurality of items; and
extracting user-item interaction features related to interactions between a user and an item in each of the user-item pair combinations.

3. The method of claim 2, further comprising computing coefficients for the user features, the item features, and the user-item interaction features of the plurality of user-item pair combinations for the generalized linear model, by adding the correction parameter scores and the features of the plurality of user-item pair combinations to the generalized linear model.

4. The method of claim 3, further comprising using the coefficients, the user features, the item features, the user-item interaction features for a user-item pair combination, and the correction parameter score for the user-item pair combination to compute the user response value for the user-item pair combination, wherein the user response value is a real value.

5. The method of claim 3, wherein the generalized linear model is a logistic regression model.

6. The method of claim 1, wherein the correction parameter score is computed by using an item-based collaborative filtering technique, and wherein the correction parameter score is a numerical value that represents a user's tendency to like an item.

7. The method of claim 1, wherein the features are extracted by using a content based filtering technique.

8. A system comprising:
a features engine to identify features related to a plurality of users and a plurality of items;
a correction parameter engine to compute a correction parameter score for each of a plurality of user-item pair combinations;
a response value engine to compute a user response value for a user-item pair combination by applying a generalized linear model to the features of the user-item pair combination and augmenting the generalized linear model with the correction parameter score for the user-item pair combination; and
a recommender engine to provide an item recommendation based on the user response value.

9. The system of claim 8, wherein the features engine is further to:
extract user features related to each user from the plurality of users;
extract item features related to each item from the plurality of items; and
extract user-item interaction features related to interactions between a user and an item in each of the user-item pair combinations.

10. The system of claim 9, wherein the response value engine is further to:
compute coefficients for the user features, the item features, and the user-item interaction features of the plurality of user-item pair combinations for the generalized linear model, by adding the correction parameter scores and the features of the plurality of user-item pair combinations to the generalized linear model.

11. The system of claim 10, the response value engine is further to:
use the coefficients, the user features, the item features, the user-item interaction features for a user-item pair combination, and the correction parameter score for the user-item pair combination to compute the user response value for the user-item pair combination.

12. A non-transitory machine-readable storage medium encoded with instructions executable by at least one processor, the machine-readable storage medium comprising instructions to:
identify features related to a plurality of users and a plurality of items;
compute a correction parameter score for each of a plurality of user-item pair combinations;
compute a user response value for an identified user-item pair combination by applying a generalized linear model to the features of the user-item pair combination and augmenting the generalized linear model with the correction parameter score for the user-item pair combination; and
provide an item recommendation based on the user response value.

13. The non-transitory machine-readable storage medium of claim 12, further comprising instructions to:
extract user features related to each user from the plurality of users;
extract item features related to each item from the plurality of items; and
extract user-item interaction features related to interactions between a user and an item in each of the user-item pair combinations.

14. The non-transitory machine-readable storage medium of claim 13, further comprising instructions to compute coefficients for the user features, the item features, and the user-item interaction features of the plurality of user-item pair combinations for the generalized linear model, by adding the correction parameter scores and the features of the plurality of user-item pair combinations to the generalized linear model.

15. The non-transitory machine-readable storage medium of claim 14, further comprising instructions to use the coefficients, the user features, the item features, the user-item interaction features for the identified user-item pair combination, and the correction parameter score for the identified user-item pair combination to compute the user response value for the identified user-item pair combination, wherein the user response value is a real value.
